(19) United States
(12) Patent Application Publication
(10) Pub. No.: US 2006/0132023 A1
(43) Pub. Date: Jun. 22, 2006

(54) Image display device and method of manufacturing the same

(76) Inventors: Akiyoshi Yamada, Fukaya-shi (JP); Hirotaka Unno, Fukaya-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/292,354

(22) Filed: Dec. 2, 2005

Related U.S. Application Data
(63) Continuation of application No. PCT/JP04/08079, filed on Jun. 3, 2004.

(30) Foreign Application Priority Data
Jun. 4, 2003 (JP) 2003-159528

(51) Int. Cl. H01J 1/62

(52) U.S. Cl. 313/496

(57) ABSTRACT

A vacuum envelope of an image display device includes a front substrate and a rear substrate located opposite each other and a sealing portion which seals together respective peripheral portions of the front substrate and the rear substrate. The sealing portion includes a framework and a sealing material which extend along the peripheral edge portions of the front substrate and the rear substrate. The framework has a core member formed of a metal and a metal coating covering a surface of the core member.

### CROSS-REFERENCE TO RELATED APPLICATIONS

This is a Continuation Application of PCT Application No. PCT/JP2004/008079, filed Jun. 3, 2004, which was published under PCT Article 21(2) in Japanese.

This application is based upon and claims the benefit of priority from prior Japanese Patent Application No. 2003-159528, filed Jun. 4, 2003, the entire contents of which are incorporated herein by reference.

### BACKGROUND OF THE INVENTION

1. Field of the Invention

This invention relates to a flat image display device, having opposed substrates and a large number of electron emitting elements located inside one of the substrates, and a method of manufacturing the same.

2. Description of the Related Art

In recent years, various flat display devices have been developed as a next generation of lightweight, thin display devices to replace cathode-ray tubes (CRT). These flat display devices include liquid crystal displays (LCDs), plasma display panels (PDPs), field emission display (FED), surface-conduction electron emission displays (SEDs), etc. In an LCD, the intensity of light is controlled by utilizing the orientation of a liquid crystal. In a PDP, phosphors are caused to glow by ultraviolet rays that are produced by plasma discharge. In an FED, phosphors are caused to glow by electron beams from field-emission electron emitting elements. An SED is one of FEDs and uses surface-conduction electron emitting elements.

An FED or SED, for example, generally has a front substrate and a rear substrate that are opposed to each other across a predetermined gap. These substrates have their respective peripheral portions joined together by a frame body in the form of a rectangular frame, thereby constituting a vacuum envelope. A phosphor screen is formed on the inner surface of the front substrate, and a large number of electron emitting elements for use as electron emission sources that excite the phosphors to luminescence are provided on the inner surface of the rear substrate.

In order to support an atmospheric load that acts on the rear substrate and the front substrate, a plurality of support members are arranged between these substrates. The potential on the rear substrate side is substantially ground potential, and an anode voltage is applied to the fluorescent screen. Electron beams emitted from the electron emitting elements are applied to red, green, and blue phosphors that constitute the phosphor screen, whereby the phosphors are caused to glow and display an image.

According to the image display device, the thickness of the display device can be reduced to several millimeters or thereabout. When compared with a CRT that is used as a display of an existing TV or computer, therefore, it can be made lighter in weight and thinner.

In the FED and SED of this type, a very high degree of vacuum is required of the envelope. There is proposed a method in which a front substrate, a rear substrate, and a frame body that constitute an envelope are finally assembled in a vacuum tank, as means for evacuating the envelope.

In this method, the front substrate, the rear substrate, and the frame body that are first located in the vacuum tank are fully heated in advance. This is done in order to reduce gas discharge from the inner wall of the envelope that is a primary cause of lowering of the degree of vacuum of the envelope. When the front substrate, the rear substrate, and the frame body are then cooled so that the degree of vacuum in the vacuum tank is fully enhanced, a getter film for improving and maintaining the degree of vacuum of the envelope is formed on a phosphor screen. Thereafter, the front substrate, the rear substrate, and the frame body are heated again to a temperature at which a sealing material melts, and the front substrate and the rear substrate are combined in a predetermined position as they are cooled so that the sealing material solidifies.

With the vacuum envelope fabricated by this method, a sealing process doubles as a vacuum encapsulation process, and no time is needed to exhaust the interior of the envelope through an exhaust tube. Besides, a very satisfactory degree of vacuum can be obtained.

In performing assembly in a vacuum, however, processing in the sealing process is multiplex, including heating, position alignment, and cooling, and the front substrate and the rear substrate must continue to be kept in the predetermined position for a long time during which the sealing material melts and solidifies. Further, there are problems in productivity and characteristics related to sealing such that the front substrate and the rear substrate easily undergo thermal expansion and thermal contraction to lower the alignment accuracy as they are heated and cooled to be sealed.

Described in, for example, Jpn. Pat. Appln. KOKAI Publication No. 2002-319346, on the other hand, is a method (hereinafter referred to as electrical heating) in which a low-melting metallic sealing material, such as indium that melts at a relatively low temperature, is filled between a front substrate and a sidewall, and the sealing material is energized so that the sealing material itself is heated and melted with the resulting Joule heat, whereby a pair of substrates and a framework are coupled together. According to this method, enormous time need not be spent to cool the substrates, so that the substrates can be joined together to form an envelope in a short time.

In the conventional method described above, a metal frame may possibly be used as the framework. In this case, compared with a case where a glass frame is used as the framework, the manufacturing costs can be made lower. If the affinity between the metal frame and the sealing material is poor in the case where the metal frame is used, however, it is hard securely to seal the substrates together. Thus, the sealing is so incomplete that a leak may possibly occur. If leakage from the sealing portion occurs, it is hard to maintain a high degree of vacuum in the envelope, so that the display performance and life of the display device are lowered.

### BRIEF SUMMARY OF THE INVENTION

This invention has been made in consideration of these circumstances, and its object is to provide an image display device, capable of steadily retaining high airtightness and maintaining high display performance for a long period of time, and a method of manufacturing the same.

An image display device according to an aspect of the invention comprises: an envelope having a front substrate and a rear substrate located opposite each other and a sealing portion which seals together respective peripheral edge portions of the front substrate and the rear substrate, the sealing portion including a framework and a sealing material which extend along the peripheral edge portions of the front substrate and the rear substrate, the framework having a core member formed of a metal and a metal coating covering a surface of the core member.

According to another aspect of the invention, there is provided a method of manufacturing an image display device which comprises an envelope having a front substrate and a rear substrate located opposite each other and a sealing portion which seals together respective peripheral edge portions of the front substrate and the rear substrate, the method comprising:

forming a sealing material layer so as to cover the whole circumference of a peripheral edge portion of an inner surface of at least one of the front substrate and the rear substrate; locating the front substrate and the rear substrate having the sealing material layer thereon opposite to each other; locating between the peripheral edge portions of the respective inner surfaces of the front substrate and the rear substrate a framework which extends along the peripheral edge portions of the front substrate and the rear substrate, the framework having a core member formed of a metal and a metal coating covering a surface of the core member; heating the sealing material layer to melt or soften a sealing material and pressurizing the front substrate and the rear substrate in a direction to approach each other, thereby sealing the respective peripheral edge portions of the front substrate and the rear substrate.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a perspective view showing an FED according to an embodiment of this invention;

FIG. 2 is a perspective view showing the FED cleared of its front substrate;

FIG. 3 is a sectional view taken along line III-III of FIG. 1;

FIG. 4 is a plan view showing a phosphor screen of the FED;

FIG. 5 is a sectional view showing a state in which the front substrate and a rear substrate are located opposite each other in a manufacturing process for the FED;

FIG. 6 is a diagram schematically showing a vacuum processor used in the manufacture of the FED;

FIGS. 7A, 7B, 7C and 7D are sectional views individually showing sealing portions of FED's according to other embodiments of this invention;

FIG. 8 is a sectional view showing a sealing portion of an FED according to still another embodiment of this invention; and

FIG. 9 is a sectional view showing a sealing portion of an FED according to another embodiment of this invention.

### DETAILED DESCRIPTION OF THE INVENTION

An embodiment in which an image display device according to this invention is applied to an FED will now be described in detail with reference to the drawings.

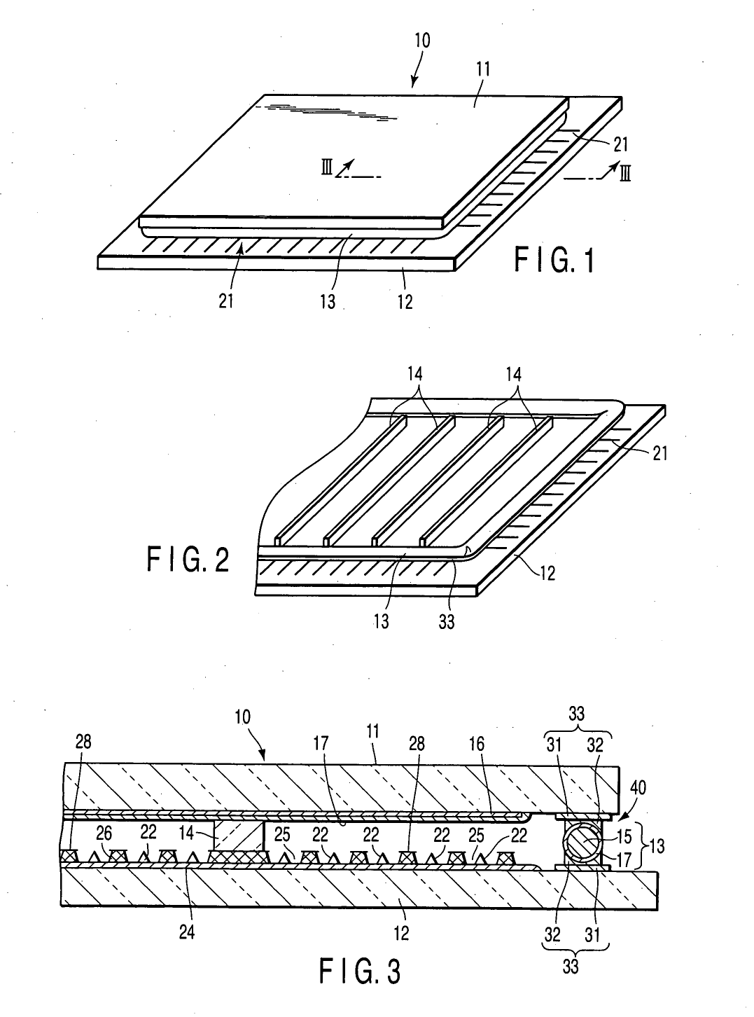

As shown in FIGS. 1 to 3, this FED comprises a front substrate 11 and a rear substrate 12, which are formed of a rectangular glass plate as an insulating substrate each. These substrates are located opposite each other with a gap of about 1.5 to 3 mm between them. The front substrate 11 and the rear substrate 12 have their respective peripheral edge portions joined together by a sidewall 13 in the form of a rectangular frame, thereby forming a flat, rectangular vacuum envelope 10 of which the interior is kept at a vacuum.

The respective peripheral edge portions of the front substrate 11 and the rear substrate 12 are joined together by a sealing portion 40. Specifically, the sidewall 13 that functions as a framework is located between a sealing surface situated on the peripheral edge portion of the inner surface of the front substrate 11 and a sealing surface situated on the peripheral edge portion of the inner surface of the rear substrate 12. Spaces between the front substrate 11 and the sidewall 13 and between the rear substrate 12 and the sidewall 13 are sealed individually with sealing layers 33, in which ground layers 31 formed individually on the respective sealing surfaces of the substrates and indium layers 32 formed individually on the ground layers are fused together. These sealing layers 33 and the sidewall 13 constitute the sealing portion 40.

In the present embodiment, the cross-sectional shape of the sidewall 13 is substantially circular. The indium layers 32 are filled individually between the sealing surface of the front substrate 11 and the outer surface of the sidewall 13 and between the sealing surface of the rear substrate 12 and the outer surface of the sidewall.

In order to support an atmospheric load that acts on the rear substrate 12 and the front substrate 11, a plurality of plate-shaped support members 14 are provided in the vacuum envelope 10. These support members 14 extend parallel to the short sides of the vacuum envelope 10 and are arranged at given intervals along a direction parallel to the long sides. The shape of the support members 14 is not limited particularly to a plate shape, but columnar support members may be used instead.

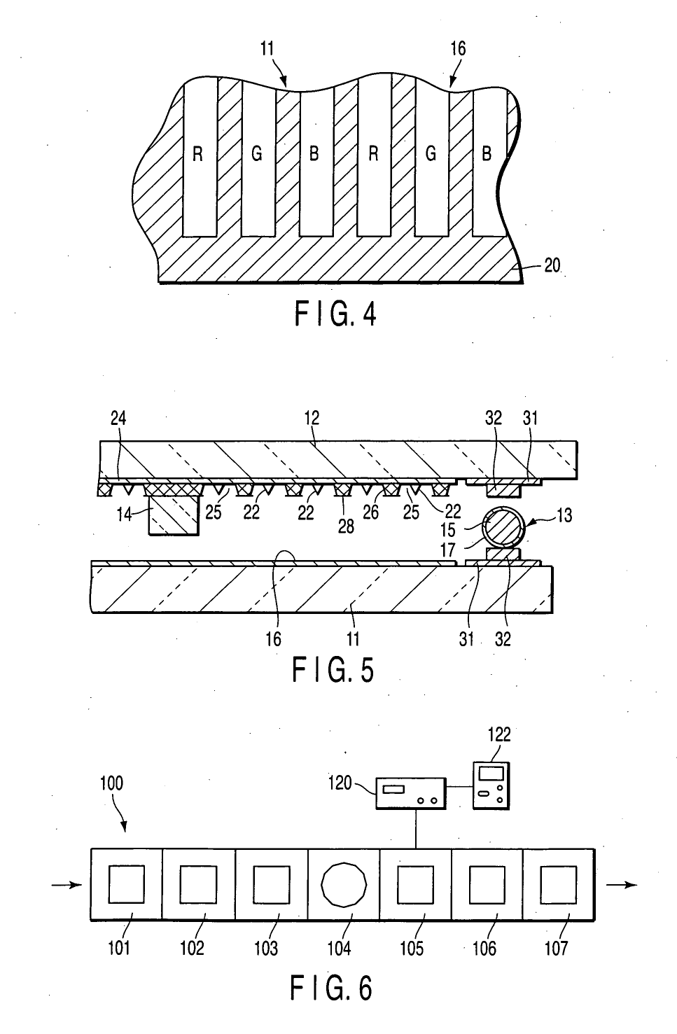

As shown in FIG. 4, a phosphor screen 16 shown is formed on the inner surface of the front substrate 11. The phosphor screen 16 is formed by arranging red, green, and blue stripe-shaped phosphor layers R, G and B and a black light absorbing layer 20 as a non-luminescent portion that is situated between these phosphor layers. The phosphor layers R, G, and B extend parallel to the short sides of the vacuum envelope 10 and are spaced in a direction parallel to the long sides. A metal back 17, which is formed of, for example, an aluminum layer, is deposited on the phosphor screen 16, and a getter film, not shown, is formed on the metal back.

Provided on the inner surface of the rear substrate 12 are a large number of electron emitting elements 22 for use as electron emission sources that individually emit electron beams and excite the phosphor layers R, G, and B. These electron emitting elements 22 are arranged in a plurality of columns and a plurality of rows corresponding to pixels, individually.

A number of wires 21 for supplying video signals with the electron emitting elements 22 are on the inner surface of the rear substrate 12 in an matrix manner. The end of each wire is led out to the periphery of the rear substrate.

The following is a detailed description of a manufacturing method for the FED constructed in this manner.

First, the phosphor screen 16 is formed on a plate glass that forms the front substrate 11. A plate glass that is as large as the front substrate 11 is prepared, and stripe patterns of phosphor layers are formed on the plate glass with a plotter machine. The plate glass having the phosphor stripe pattern thereon and the plate glass for the front substrate are placed on a positioning jig, set on an exposure stage, and exposed and developed, whereupon the phosphor screen 16 is formed.

Consequently, the electron emitting elements 22 are formed on a plate glass for the rear substrate. In this case, the electrically conductive cathode layer 24 with a matrix shape is formed on the plate glass, and the insulating film, a silicon dioxide film, is formed on the electrically conductive cathode layer by the thermal oxidation method, CVD method, or sputtering method, for example. Thereafter, a metal film of molybdenum or niobium for gate electrode formation is formed on the insulating film by the sputtering method or electron beam vapor deposition method, for example. Then, a resist pattern of a shape corresponding to the gate electrode to be formed is formed on this metal film by lithography. The metal film is etched by the wet etching method or dry etching method using this resist pattern as a mask, whereupon the gate electrode 28 is formed.

Since high voltage is applied to the phosphor screen 16, high strain-point glass is used for the front substrate 11, rear substrate 12, and spacers 14.

Then, the insulating film is etched by the wet etching method or dry etching method using the resist pattern and the gate electrode as masks, whereupon the cavities 25 are formed. After the resist pattern is removed, a separation layer of, e.g., aluminum or nickel is formed on the gate electrode 28 by electron beam vapor deposition in a direction at a given angle to the surface of the rear substrate 12. Thereafter, a material for cathode formation, e.g., molybdenum, is deposited on the surface of the rear substrate 12 at right angles thereto by the electron beam vapor deposition method. Thereupon, the electron emitting elements 22 are formed inside the cavities 25, individually. Subsequently, the separation layer, along with the metal film formed thereon, is removed by the liftoff method.

Subsequently, the sidewall 13 that is located on the respective peripheral edge portions of the substrates is formed. The sidewall 13 is formed of a metallic round rod or wire as a core member 15 having a circular cross section and a plated layer 17 as a metal coating that covers the outer surface of the core member. An NiFe alloy that has a thermal expansion coefficient substantially equal to that of glass that forms the substrates is used for the core member 15. Ag is used for the plated layer 17.

In forming the sidewall 13, the core member 15 is first bent into a rectangular frame to meet a required size. There are three bent spots that correspond individually to three corner portions of the sidewall. A portion that corresponds to the one remaining corner portion of the sidewall 13 is formed by welding the opposite ends of the round rod or wire together by means of a laser welder. As this is done, the sidewall is fabricated by instantaneously melting only a welded joint by the laser welder. Preferably, no irregularities should be left at the junction during welding. If irregularities are produced, however, the sidewall can be used satisfactorily by being flattened by a metal file or the like.

Then, the surface of the core member 15 is plated with Ag. First, the core member 15 of the NiFe alloy is washed in pure water and alcohol and dried. The core member 15 is put into a plating bath, and the Ag plated layer 17 is formed to a thickness of about 2 to 7 μm by electroplating. Thereafter, the core member 15 having the plated layer 17 formed thereon is washed in pure water and alcohol and dried. In order to enhance the affinity and adhesion between the NiFe alloy and the Ag plating, the surface of the core member 15 is blasted before it is plated, whereby irregularities with heights of about 0.01 to 1 μm, which are small enough than the layer thickness of the plated layer 17, are formed on the surface. In this case, the heights of the irregularities are adjusted to about 0.05 μm. Alternatively, the plated layer 17 may be formed on an Ni plated layer or a Cu plated layer 17 that is formed on the surface of the unplated core member 15.

Then, a silver paste is applied to each of the sealing surfaces situated on the peripheral edge portions of the respective inner surfaces of the front substrate 11 and the rear substrate 12 by the screen-printing method, whereby the frame-shaped ground layers 31 are formed. Subsequently, indium for use as a metallic sealing material is spread on each ground layer 31, whereby the indium layers 32 are formed extending throughout the respective circumferences of the ground layers.

Preferably, a low-melting metallic material that has a melting point of about 350° C. or less and high adhesion and bonding properties should be used as the metallic sealing material. Indium (In) used in the present embodiment has excellent properties, such as low vapor pressure, softness for resistance to impact, low liability to be fragile at low temperature, etc., as well as a melting point as low as 156.7° C. Since it can be bonded directly to glass, depending on conditions, moreover, it is a suitable material for the object of the present invention.

Then, the rear substrate 12, having the ground layer 31 and the indium layer 32 on its sealing surface, and the front substrate 11, having the sidewall 13 placed on the indium layer 32, are prepared, as shown in FIG. 5. The rear substrate 12 and the front substrate 11 are held by means of a jig or the like with their respective sealing surfaces facing each other at a given distance from each other. As this is done, the front substrate 11 is located under the rear substrate 12 with its sealing surface upward, for example. In this state, the front substrate 11 and the rear substrate 12 are put into a vacuum processor.

As shown in FIG. 6, a vacuum processor 100 has a load chamber 101, baking and electron beam cleaning chamber 102, cooling chamber 103, vapor deposition chamber 104 for getter film, assembly chamber 105, cooling chamber 106, and unload chamber 107, which are successively arranged side by side. Each chamber is formed as a processing chamber that enables vacuum processing, and all the chambers are evacuated during the manufacture of the FED. Each two adjacent processing chambers are connected by a gate valve or the like.

The front substrate 11 and the rear substrate 12 having the sidewall 13 thereon are put into the load chamber 101. After a vacuum is formed in the load chamber 101, they are delivered to the baking and electron beam cleaning chamber 102. When a high degree of vacuum of about 10⁻⁵ Pa is attained in the baking and electron beam cleaning chamber 102, the rear substrate 12 and the front substrate 11 are heated to a temperature of about 300° C. and baked, whereby surface-adsorbed gas of each member is fully discharged.

The indium layers (having a melting point of about 156° C.) 32 melt at this temperature. Since the indium layers 32 are formed on the highly affinitive ground layers 31, however, their flows are held on the ground layers. The sidewall 13 and the front substrate 11 are bonded together by the melted indium. The front substrate 11 to which the sidewall 13 is bonded will hereinafter be referred to as the front-substrate-side assembly.

In the baking and electron beam cleaning chamber 102, a phosphor screen surface of the front-substrate-side assembly and an electron emitting element surface of the rear substrate 12 are irradiated with an electron beam from an electron beam generator (not shown) attached to the baking and electron beam cleaning chamber 102 as heating is performed. Since this electron beam is deflected and scanned by a deflector that is attached to the outside of the electron beam generator, the phosphor screen surface and the electron emitting element surface can be entirely subjected to electron beam cleaning.

After the heating and the electron beam cleaning, the front-substrate-side assembly and the rear substrate 12 are delivered to the cooling chamber 103 and cooled to a temperature of, for example, about 100° C. Subsequently, the front-substrate-side assembly and the rear substrate 12 are delivered to the vapor deposition chamber 104 for getter film, in which a Ba film is vapor-deposited as a getter film on a phosphor screen and a metal back. The surface of the Ba film can be prevented from being soiled by oxygen, carbon, etc., so that its active state can be maintained.

Then, the front-substrate-side assembly and the rear substrate 12 are delivered to the assembly chamber 105 and heated to 200° C. therein. Thereupon, the indium layers 32 are melted again into a liquid or softened. In this state, the sidewall 13 and the rear substrate 12 are bonded together with the indium layers 32 between them and pressurized toward each other under a given pressure. As this is done, some of the pressurized melted indium is urged to flow toward a display region or a wiring region. Since the sidewall 13 has a circular cross section, however, the melted indium stays in a wide portion between the sealing surface of the rear substrate 12 and the outer surface of the sidewall, and is prevented from flowing beyond the width of the sidewall toward the display region or the wiring region. Also in the front-substrate-side assembly, the remelted indium stays in a wide portion between the sealing surface of the front substrate 11 and the outer surface of the sidewall 13, and is prevented from flowing beyond the width of the sidewall toward the display region or the wiring region. Thus, the indium can be kept within the maximum width of the cross section of the sidewall 13 on both the respective sides of the front substrate 11 and the rear substrate 12.

Thereafter, the indium is slowly cooled and solidified. Thereupon, the rear substrate 12 and the sidewall 13 are sealed with the sealing layer 33 in which the indium layer 32 and the ground layer 31 are fused together. At the same time, the front substrate 11 and the sidewall 13 are sealed with the sealing layer 33 in which the indium layer 32 and the ground layer 31 are fused together, whereby the vacuum envelope 10 is formed.

After the vacuum envelope 10, formed in this manner, is cooled to normal temperature in the cooling chamber 106, it is taken out of the unload chamber 107. In these processes, the vacuum envelope of the FED can be obtained having a high vacuum kept therein.

According to the FED constructed in this manner and its manufacturing method, the front substrate 11 and the rear substrate 12 are sealed together in the vacuum atmosphere. Therefore, the surface-adsorbed gas of the substrates can be fully discharged by jointly using baking and electron beam cleaning, and a satisfactory gas adsorption effect can be obtained without oxidizing the getter film. Thus, the FED can be obtained having the capability to maintain a high degree of vacuum.

The sidewall 13 that constitutes the sealing portion 40 is formed by coating the core member 15 with the plated layer 17, and this plated layer is very affinitive to indium as the sealing material. Therefore, the spaces between the front substrate and the sidewall and between the rear substrate and the sidewall can be securely sealed. Thus, leakage from the sealing portion can be prevented, so that the vacuum envelope can be obtained having high airtightness. In consequence, the image display device can be obtained that maintains a high degree of vacuum and shows outstanding display performance for a long period of time. The framework that is obtained by molding the metallic wire or metallic rod is used as the sidewall. If the image display device has a large size of 50 inches or more, therefore, it can be securely sealed to ensure excellent mass-producibility.

In the embodiment described above, the NiFe alloy is used for the core member 15. However, the material is not limited to this, but should only be a material that has a thermal expansion coefficient relatively similar to that of the front substrate and the rear substrate. For example, a metal, such as a simple or alloy that contains any of elements including Fe, Ni, and Ti, may be used for the purpose. The plated layer 17 is not limited to Ag but is only expected to be highly affinitive to indium and suited for the maintenance of airtightness. It may be formed of a metal or alloy that contains at least one of elements including Au, Ag, Cu, Pt, Ni, and In. The sealing material is not limited to indium but may be an alloy that contains at least In or Ga. The method of forming the metal coating on the framework core member is not limited to plating but may be vapor deposition processing, such as CVD or PVD, or sputtering.

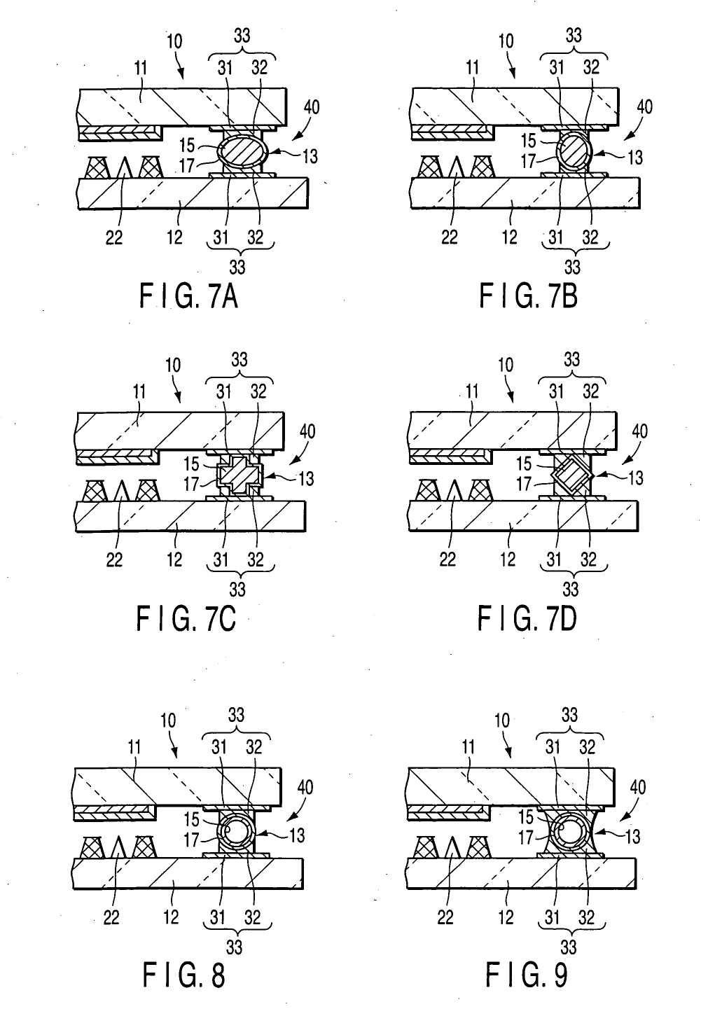

In the embodiment described above, the cross-sectional shape of the sidewall 13 is circular. Alternatively, however, the sidewall 13 may be formed having an elliptic, cruciform, or rhombic cross-sectional shape, as shown in FIGS. 7A, 7B, 7C and 7D.

The sidewall 13 is not limited to a solid structure but may be a hollow one, as shown in FIG. 8. Also in this case, the cross-sectional shape of the sidewall 13 is not limited to the circular shape, but may be an elliptic, cruciform, or rhombic cross-sectional shape, as in the embodiments shown in FIGS. 7A, 7B, 7C and 7D.

As shown in FIG. 9, the sealing layer 33 between the sidewall 13 and the front substrate 11 and the sealing layer 33 between the sidewall 13 and the rear substrate 12 may be connected to each other around the sidewall so that the sidewall 13 is embedded in the sealing layers 33.

In the foregoing embodiments, the spaces between the sidewall and the front substrate and between the sidewall and the rear substrate are sealed with a sealing material, such as indium, during the manufacture of the vacuum envelope. Alternatively, however, remaining junctions may be joined together in a vacuum by the aforementioned process after the sidewall and the front substrate or the rear substrate are bonded together in advance with a sealing material, such as indium, or low-melting glass in the atmosphere.

In joining the front substrate and the rear substrate together, according to the foregoing embodiment, moreover, these substrates are heated to about 200° C. to melt or soften the indium layers in the assembly chamber. Instead of heating the entire substrates, however, the indium layers may be melted or softened by electrical heating. More specifically, the sidewall 13 may be energized to be heated with Joule heat with the front substrate and the rear substrate pressurized in a direction to approach each other so that the sidewall is sandwiched between the indium layers. As this is done, the indium layers 32 are melted by this heat to seal the substrates. In this case, the sidewall 13 is formed of an electrically conductive material. In this case, moreover, if the sidewall 13 is formed having a hollow structure, as shown in FIG. 8, it can be configured to have high resistance and be easily heatable. At the same time, the heat capacity of the sidewall 13 is reduced, so that the sidewall can be cooled in a short time after the front substrate and the rear substrate are sealed together. In consequence, the manufacturing efficiency can be improved.

Alternatively, the substrates may be sealed by melting or softening the indium layers 32 with Joule heat that is produced as the indium layers 32 are directly energized in place of the sidewall 13.

The present invention is not limited directly to the embodiments described above, and its components may be embodied in modified forms without departing from the spirit of the invention. Further, various inventions may be made by suitably combining a plurality of components described in connection with the foregoing embodiments. For example, some of all the components according to the foregoing embodiment may be omitted. Furthermore, components according to different embodiments may be combined as required.

In the embodiments described above, for example, the field-emission electron emitting elements are used as the electron emitting elements. Alternatively, however, they may be replaced with any other electron emitting elements, such as pn-type cold-cathode devices or surface-conduction electron emitting elements. This invention is not limited to those display devices, such as an FED, SED, etc., which require a vacuum envelope, but is also applicable to any other image display devices such as a PDP, an electroluminescence (EL) display.

What is claimed is:

1. An image display device comprising:
an envelope having a front substrate and a rear substrate located opposite each other and a sealing portion which seals together respective peripheral edge portions of the front substrate and the rear substrate,
the sealing portion including a framework and a sealing material which extend along the peripheral edge portions of the front substrate and the rear substrate, the framework having a core member formed of a metal and a metal coating covering a surface of the core member.

2. The image display device according to claim 1, wherein the metal coating is formed of a metal which contains at least one of elements including Au, Ag, Cu, Pt, Ni, and In.

3. The image display device according to claim 1, wherein the framework has a plated layer which contains at least one of elements including Cu, Ni, Au, and Pt and is formed on the surface of the core member, and the metal coating is formed overlapping the plated layer.

4. The image display device according to claim 1, wherein the metal coating is formed of a plated layer.

5. The image display device according to claim 1, wherein the core member is formed of a pure metal or an alloy which contains at least one of elements including Ni, Fe, and Ti.

6. The image display device according to claim 1, wherein the surface of the core member has irregularities with heights of 0.01 to 1 μm.

7. The image display device according to claim 1, wherein the sealing material is provided between the framework and the front substrate and between the framework and the rear substrate.

8. The image display device according to claim 1, wherein the sealing material is a low-melting metal.

9. The image display device according to claim 8, wherein the sealing material has electrical conductivity.

10. The image display device according to claim 1, wherein the sealing material is indium or an alloy which contains indium.

11. The image display device according to claim 1, which comprises a phosphor layer provided on the inner surface of the front substrate and a plurality of electron sources which are provided on the inner surface of the rear substrate and excite the phosphor layer.

12. The image display device according to claim 1, wherein the framework has a circular cross sectional shape.

13. The image display device according to claim 1, wherein the framework has an elliptic cross sectional shape.

14. The image display device according to claim 1, wherein the framework has a cruciform cross sectional shape.

15. The image display device according to claim 1, wherein the framework has a rhombic cross sectional shape.

16. The image display device according to claim 1, wherein the framework has a hollow structure.

17. A method of manufacturing an image display device which comprises an envelope having a front substrate and a rear substrate located opposite each other and a sealing portion which seals together respective peripheral edge portions of the front substrate and the rear substrate, the method comprising:
forming a sealing material layer so as to cover the whole circumference of a peripheral edge portion of an inner surface of at least one of the front substrate and the rear substrate;
locating the front substrate and the rear substrate having the sealing material layer thereon opposite to each other;
locating between the peripheral edge portions of the respective inner surfaces of the front substrate and the rear substrate a framework which extends along the peripheral edge portions of the front substrate and the rear substrate, the framework having a core member formed of a metal and a metal coating covering a surface of the core member;
heating the sealing material layer to melt or soften a sealing material and pressurizing the front substrate and the rear substrate in a direction to approach each other, thereby sealing the respective peripheral edge portions of the front substrate and the rear substrate.

18. The method of manufacturing an image display device according to claim 17, wherein the front substrate and the rear substrate are heated in a vacuum to melt or soften the sealing material layer.

19. The method of manufacturing an image display device according to claim 17, wherein at least one of the framework and the sealing material layer is energized in a vacuum to melt or soften the sealing material layer.
